(19) United States
(12) Patent Application Publication
(10) Pub. No.: US 2026/0226696 A1
(43) Pub. Date: Aug. 6, 2026

(54) MODULAR PILE SYSTEM

(71) Applicant: Nextpower LLC, Fremont, CA (US)

(72) Inventor: Abhimanyu Anil Sable, Hyderabad (IN)

(21) Appl. No.: 19/431,995

(22) Filed: Dec. 23, 2025

Related U.S. Application Data
(60) Provisional application No. 63/752,514, filed on Jan. 31, 2025.

(51) Int. Cl. E02D 5/52; E02D 5/56; F24S 25/617

(52) U.S. Cl. CPC E02D 5/52; E02D 5/56; F24S 25/617

(57) ABSTRACT

A modular pile system for a solar tracking system including an elongate hollow tube extending longitudinally from a first end to a second end, the elongate tube having a longitudinal axis, one or more mounting holes positioned along the longitudinal axis of the elongate hollow tube, a plurality of holes positioned adjacent the second end of the elongate hollow tube, and one or more interchangeable components configured to be coupled to the second end of the elongate hollow tube via the plurality of holes, the one or more interchangeable components configured for engaging with soil in which the ground pile is implanted.

### RELATED APPLICATIONS

This application claims the benefit of U.S. Provisional Patent Application No. 63/752,514, filed Jan. 31, 2025, the entire contents of which are incorporated herein by reference.

### TECHNICAL FIELD

This disclosure relates generally to solar power generation systems, and more particularly, to support structures for solar arrays within a solar tracking system.

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Solar tracking systems can be used to dynamically orient a plurality of solar modules, for instance, by moving the solar modules throughout the course of a given day to track the movement of the sun and thereby increase the efficiency and productivity of the solar modules. Typically, solar tracking systems require hundreds or thousands of acres of land for construction and installation. Soil characteristics can vary significantly across the land, thus a singular solution for solar tracker foundations is not typically the most cost-effective option. Oftentimes, to address this, the land may be divided into various zones, requiring multiple types of piles for each zone adding considerable complexity and cost due to the increased number of piles required for the project. The present disclosure seeks to address the shortcomings of prior tracker systems.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2A is a perspective view of a tubular pipe for a solar tracker foundation pile, in accordance with the disclosure;

FIG. 2B is a front-side view of the tubular pipe, as in FIG. 2A;

FIG. 2C is a left-side view of the tubular pipe, as in FIG. 2A;

FIG. 2D is a back-side view of the tubular pipe, as in FIG. 2A;

FIG. 2E is a right-side view of the tubular pipe, as in FIG. 2A;

FIG. 3A is a perspective view of an example solar tracker foundation pile in accordance with the disclosure;

FIG. 3B is an isolated, perspective view of a screw pile of the solar tracker foundation pile, as in FIG. 3A;

FIG. 3C is an isolated, front-side view of the screw pile of the solar tracker foundation pile, as in FIG. 3A;

FIG. 4A is a perspective view of an example solar tracker foundation pile in accordance with the disclosure;

FIG. 4B is an isolated, perspective view of a ramming pile of the solar tracker foundation pile, as in FIG. 4A;

FIG. 4C is an isolated, front-side view of the ramming pile of the solar tracker foundation pile, as in FIG. 4A;

FIG. 5A is a perspective view of an example solar tracker foundation pile in accordance with the disclosure;

FIG. 5B is an isolated, perspective view of a portion of the solar tracker foundation pile, as in FIG. 5A, including a first and second stopper;

FIG. 5C is an isolated, front-side view of a stabilizing panel of the solar tracker foundation pile, as in FIG. 5A;

FIG. 5D is an isolated, back-side view of a stabilizing panel of the solar tracker foundation pile, as in FIG. 5A;

FIG. 6 is a perspective view of an example solar tracker foundation pile in accordance with the disclosure;

FIG. 7A is an isolated, perspective view of a helical blade of the solar tracker foundation pile, as in FIGS. 5A and 6;

FIG. 7B is a rear-side view of the helical blade, as in FIG. 7A;

FIG. 8A is a perspective view of an example solar tracker foundation pile in accordance with the disclosure;

FIG. 8B is an isolated, perspective view of a helical blade of the solar tracker foundation pile, as in FIG. 8A;

FIG. 8C is an isolated, right-side view of the helical blade of the solar tracker foundation pile, as in FIG. 8B;

FIG. 8D is an isolated, back-side view of the helical blade of the solar tracker foundation pile, as in FIG. 8B;

FIG. 9 illustrates an example grid map in accordance with the present disclosure;

FIG. 10 is a flow chart illustrating a method of installing a modular ground pile into an area of land having various terrain; and

FIG. 11 illustrates an example kit in accordance with the present disclosure.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

During operation of solar trackers, hundreds or thousands of acres of land are typically required for construction and installation. Soil characteristics of the land can vary significantly. In such cases, a single solution for solar tracker foundations may not be the most cost-effective option. To address this, oftentimes, the land may be divided into various zones where soil within each zone may have similar characteristics. As described herein, a modular pile system may include a tubular pipe and two or more interchangeable components. Each one of the two or more interchangeable components may be configured to engage with the underlying ground in one of the various zones of land. For example, a helical blade attachment may be suitable for engagement with a zone of land including heavy sand. In other examples, a screw pile attachment may be suitable for engagement with a zone of land including dense clay. In such examples, a supply of tubular pipes and a supply of the two or more interchangeable components may be delivered to an installation site, such as, for example helical blade attachments and screw pile attachments. At one of the various zones of land, the most suitable component for that particular zone of land (e.g., helical blade attachment for sandy soil) may be attached to one of the tubular pipes and installed into the underlying ground. At a second one of the various zones of land, the most suitable component for that particular zone of land (e.g., screw pile attachment for dense clay) may be attached to one of the tubular pipes and installed into the underlying ground. This may continue for each of the various zones of land. The use of a modular pile system having two or more interchangeable components configured to be coupled to one singular type of tubular pipe reduces the cost of production and installation for solar tracking systems.

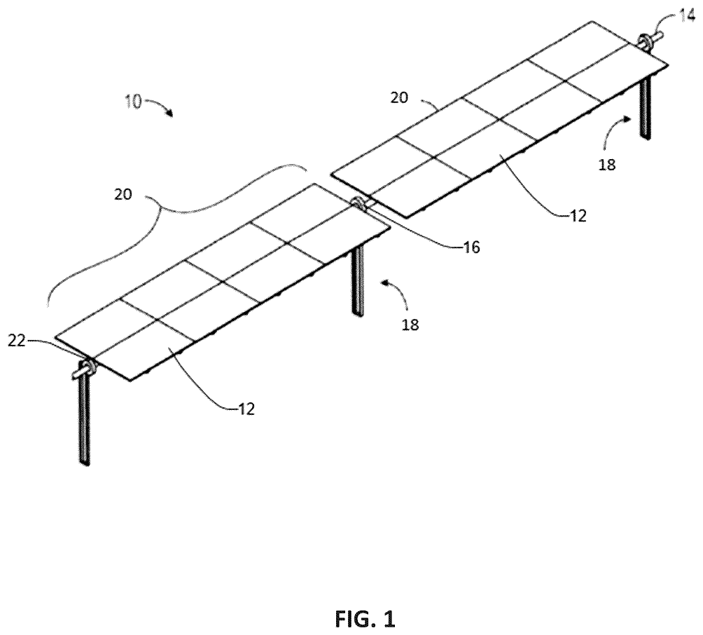

The present disclosure is directed to modular pile systems for a solar tracking system. FIG. 1 is an elevation view of a common arrangement of a solar tracker 10 provided in accordance with the present disclosure. The solar tracker 10 may be formed of a plurality of bays 20 defined by the distance between ground piles 18 (generally referenced herein as piles 18). FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or and to absorb torsional loads applied to the torque tube 14 by wind loading. In addition, since there is often just a single drive mechanism 16, the specifications for the torque tube 14 may desire to eliminate twist of the torque tube 14 along its length. Twisting of the torque tube 14 would result in the solar modules 12 being oriented differently from what is desired, and thus again reduce the output and efficiency of the solar tracker 10, particularly, as the solar tracker 10 is rotated to the extreme angles of permitted range (e.g., +/−60 degrees or more).

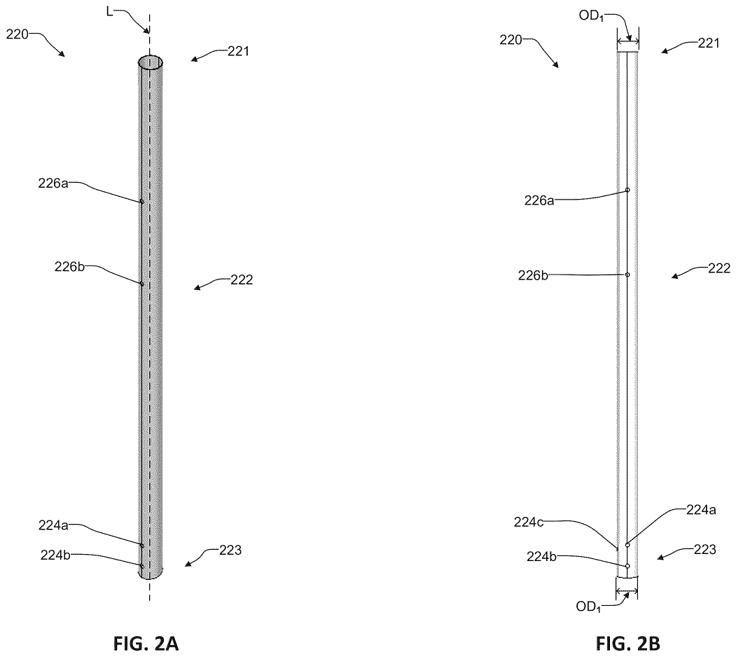

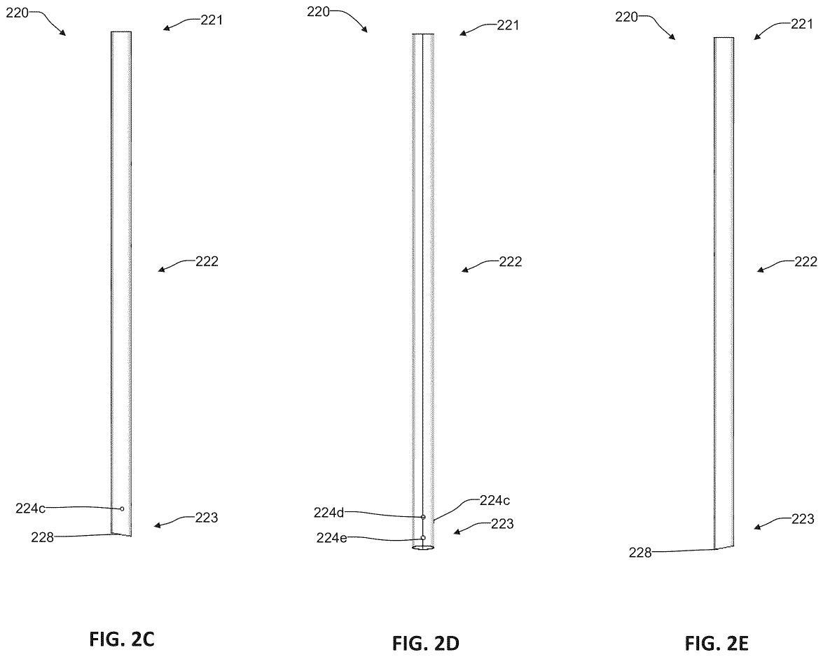

FIGS. 2A to 2E illustrate a tubular pipe 220, generally referred to herein as tube 220, for a solar tracker foundation pile (e.g., ground pile 18), in accordance with the disclosure. FIG. 2A is a perspective view of the tube 220, FIG. 2B is a front-side view of the tube 220, FIG. 2C is a left-side view of the tube 220, FIG. 2D is a back-side view of the tube 220, and FIG. 2E is a right-side view of the tube 220. The tube 220 may be an elongate tube extending longitudinally from a first end 221 to a second end 223, having a central portion 222 therebetween. The tube 220 may include a central longitudinal axis L. In some cases, the first end 221 of the tube 220 may be open and the second end 223 of the tube 220 may be open. In other cases, the first end 221 of the hollow tube 220 may be closed, and the second end 223 of the hollow tube 220 may be closed. In some cases, one of the first end 221 or the second end 223 may be open and the other of the first end 221 or the second end 223 may be closed.

In some cases, the tube 220 may include one or more mounting holes 226 that may be positioned along the length of the tube 220. The one or more mounting holes 226 may extend entirely through the hollow tube 220 (in one wall and continuing straight through and out the other wall) or the mounting holes 226 may extend partially through the hollow tube 220 (in one wall but not extending through to another wall). While only two mounting holes 226a, 226b (generally referenced herein as mounting holes 226) are shown in FIGS. 2A to 2E, it may be contemplated that the tube 220 may include four mounting holes, six mounting holes, twelve mounting holes, twenty mounting holes, or any suitable number of mounting holes as desired. The mounting holes 226 may be used to attach solar tracking components such as for example, the bearings 22 and the drive mechanism 16, as shown in FIG. 1. In some cases, the mounting holes 226 may be configured to mount an adapter which may be used to drive the tube 220 into the ground. In some cases, the mounting holes 226 may be used to attach retention features, as will be described further herein.

The tube 220 may further include a plurality of holes 224 positioned adjacent the second end 223 of the tube 220. While it is shown in FIGS. 2A to 2E that the plurality of holes 224 includes a first hole 224a, a second hole 224b, and a third hole 224c, a fourth hole 225d, and a fifth hole 225e, which are generally referred to herein as the plurality of holes 224, it will be appreciated that the plurality of holes 224 may include six holes, twelve holes, twenty holes, or any suitable number of holes as desired. The plurality of holes 224 may be used to attach various retention feature attachments to the second end 223 of the tube 220. The retention feature attachments described herein may provide enhanced stability in diverse soil conditions. The retention feature attachments may also aid in driving the tube 220 or piles (as described herein) into the ground. In some examples, the third hole 224c of the plurality of holes 224 may be positioned 90-degrees from the first hole 224 a, the second hole 224 b, the fourth hole 225 d, and the fifth hole 225e. In some examples, the third hole 224c may be configured to engage with an adapter which may be used to drive the tube 220 into the ground.

The tube 220 may be formed from aluminum, brass, carbon, stainless steel, copper, or other metal alloys. In some cases, the tube 220 may be formed via a hydroforming process. In such cases, the tube 220 may be formed of a material and a thickness appropriate for forming the particular components (e.g., blades, screws, stabilizing panel, etc.) described herein. In some cases, the tube 220 may be formed via extrusion, welding, molding, hydroforming, and/or any other suitable process. The addition of retention feature attachments (e.g., screw 350, blades 450, 550, 750, described herein) to the tube 220 during the manufacturing process may be advantageous in diverse soil conditions soil conditions (e.g., sandy soil, clay soil, silt soil, peat soil, loam soil, among others) by providing reliable support for solar trackers 10 in rural and/or urban environments.

The tube 220 may include a circular cross-section, and the first end 221 of the hollow tube 220 and the second end 223 of the hollow tube 220 include the same or a similar outer diameter OD₁, as shown in FIG. 2B. Although this may not always be the case. In some cases, the first end 221 may have an outer diameter that is different than an outer diameter of the second end 223 (e.g., smaller than or larger than). In some cases, the second end 223 of the tube 220 may include a slanted edge 228, thereby forming a sharp point to aid in driving the tube 220 into the ground. In some cases, the slanted edge 228 may include an angle in a range of about 10-degrees to about 30-degrees. In other cases, the slanted edge 228 may include an angle of about 15-degrees. In some cases, the tube 220 may include a hexagonal cross-section, a square cross-section, a rectangular cross-section, a triangular cross-section, a W-cross-section, a polygonal cross-section, or the like.

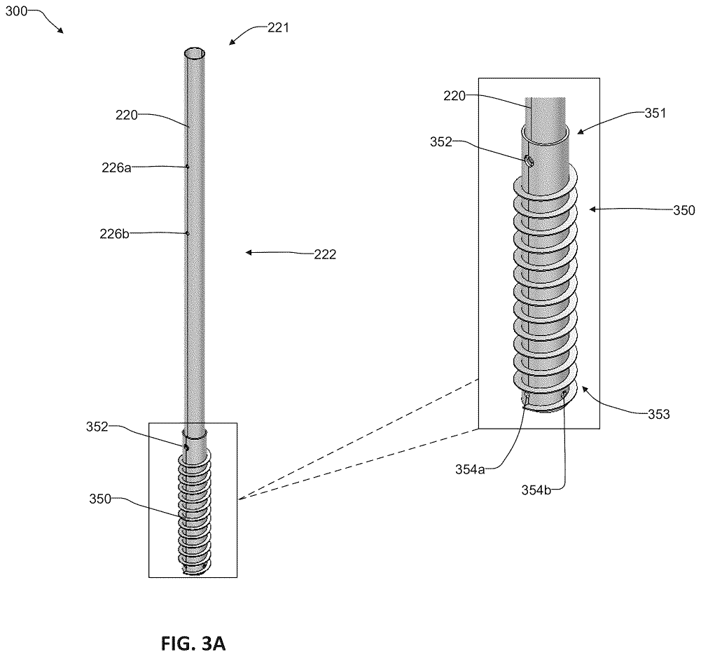

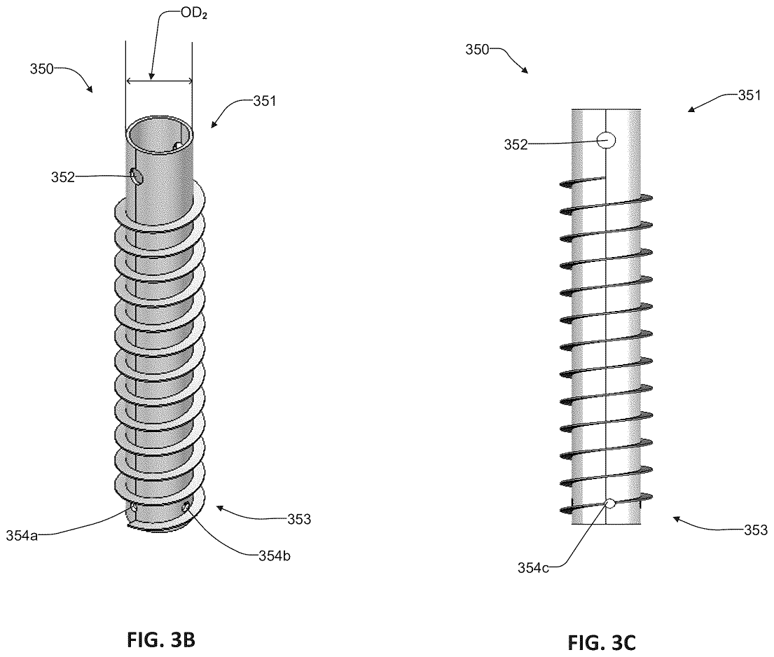

FIG. 3A is a perspective view of an example solar tracker foundation pile 300 in accordance with the disclosure. FIG. 3B is an isolated, perspective view of a screw attachment 350 of the solar tracker foundation pile 300, and FIG. 3C is an isolated, front-side view of the screw attachment 350 of the solar tracker foundation pile 300. The pile 300 may be a modular pile system 300 being formed from one of the two or more components, such as, for example, the tube 220 and the screw attachment 350.

The screw attachment 350 may include a first end 351 and a second end 353. In some cases, the first end 351 of the screw attachment 350 may be open and the second end 353 of the screw attachment 350 may be open. In other cases, the first end 351 of the screw attachment 350 may be open, and the second end 353 of the screw attachment 350 may be closed. The first end 351 and/or the second end 353 of the screw attachment 350 may be an open end may include an outer diameter OD₂ (FIG. 3B) that is greater than the outer diameter OD₁ of the tube 220. Thus, the screw attachment 350 may be configured to fit over and around the second end 223 of the tube 220. In some examples, the outer diameter OD₂ of the screw attachment 350 may be slightly larger than the outer diameter OD₁ of the tube 220 to ensure a tighter fit and minimize any gap that may be formed between the tube 220 and the screw attachment 350. For example, if the outer diameter OD₁ of the second end 223 of the tube 220 is 4 inches, then the outer diameter OD₂ of the screw attachment 350 may be 4.25 inches. This is just an example.

The first end 351 of the screw attachment 350 may further include one or more holes 352. The one or more holes 352 may extend through the screw attachment 350, as shown in FIGS. 3B to 3C. The one or more holes 352 may be configured to mount an adapter which may be used to drive the tube 220 into the ground. In some cases, the one or more holes 352 may be configured to align and engage with a plurality of holes (not explicitly shown) on the tube 220 to secure the screw attachment 350 to the tube 220. The screw attachment 350 may further include a second set of one or more holes 354a, 354b, 354c, generally referred to herein as one or more holes 354. The second set of the one or more holes 354 may be configured to align and engage with the plurality of holes 224 positioned adjacent the second end 223 of the tube 220. In some examples, the first end 351 of the screw attachment 350 may be positioned adjacent the second end 223 of the tube 220 and may slide axially over the second end 223 of the tube 220. The screw attachment 350 may move axially over the second end 223 of the tube 220 until the second set of the one or more holes 354 align with the plurality of holes 224 positioned adjacent the second end 223 of the tube 220. Alignment of the second set of the one or more holes 354 with the plurality of holes 224 may permit insertion of a coupling fastener (e.g., a bolt, screw, rivet, or the like) to securely attach the screw attachment 350 to the second end 223 of the tube 220. In some examples, the screw attachment 350 may be positioned over the second end 223 of the tube 220 such that the slanted edge 228 of the second end 223 of the tube 220 is exposed beyond the second end 353 of the screw attachment 350. The exposure of the slanted edge 228 permits engagement of the slanted edge 228 with an underlying ground to aid in driving the pile 300 into the ground.

The screw attachment 350 may be formed from helical segments forming a screw thread. Screw threads to allow the pile 300 to be screwed into the ground. Thus, the pile 300 may be configured to be screwed or threaded into the ground to anchor the solar tracker (e.g., solar tracker 10) via rotational force. Rotation of the tube 220 (e.g., pile 300) relative to underlying ground may cause the screw attachment 350 to pull the tube 220 further underground.

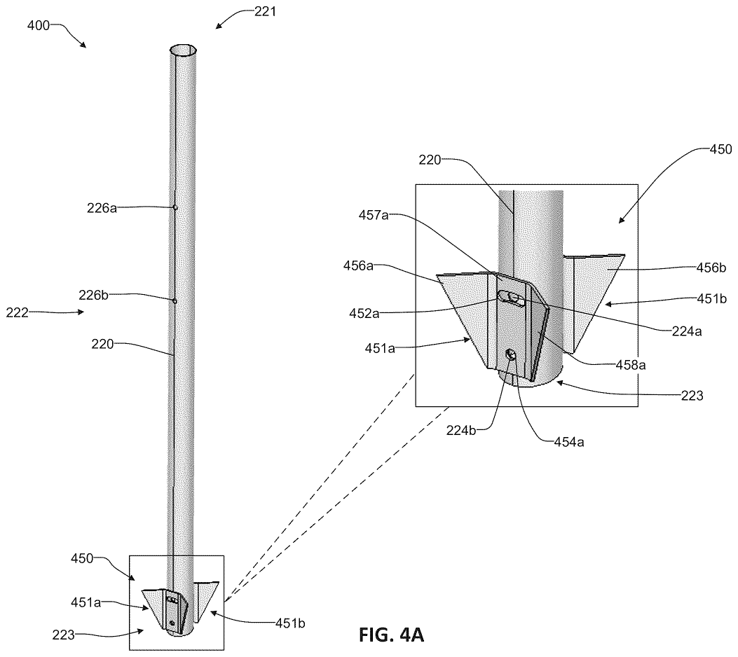

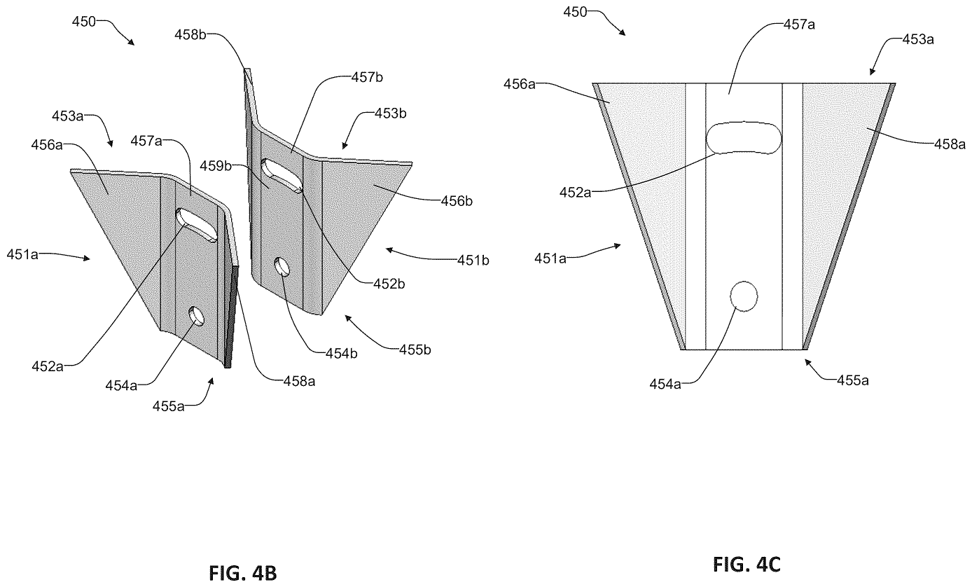

FIG. 4A is a perspective view of an example solar tracker foundation pile 400 in accordance with the disclosure. FIG. 4B is an isolated, perspective view of a ramming blade attachment 450 of the solar tracker foundation pile 400, and FIG. 4C is an isolated, front-side view of the ramming blade attachment 450 of the solar tracker foundation pile 400. The pile 400 may be a modular pile system 400 being formed from one of the two or more components, such as, for example, the tube 220 and the ramming blade attachment 450.

In some examples, the ramming blade attachment 450 may include a first ramming blade 451a and a second ramming blade 451b. The first ramming blade 451a may include a first angled portion 456a, a second angled portion 458a, and a third portion 457a. The second angled portion 458a may extend in an opposing direction lateral to the first angled portion 456a and with the third portion 457a therebetween. The first angled portion 456a and the second angled portion 458a may each extend away from the third portion 457a laterally outward at an angle. Similarly, the second ramming blade 451b may include a first angled portion 456b, a second angled portion 458b, and a third portion 457b. The second angled portion 458b may extend in an opposing direction lateral to the first angled portion 456b and with the third portion 457b therebetween. The first angled portion 456b and the second angled portion 458b may each extend away from the third portion 457b laterally outward at an angle. A back surface (shown as back surface 459b in FIG. 4B) of the third portion 457a may be configured to engage with an exterior of the tube 220. In some examples, the back surface (459b) may be a curved surface, and in other examples the back surface (459b) may be a flat surface. Although a back surface of the first ramming blade 451a is not explicitly shown, it will be appreciated that the description of the back surface 459b of the second ramming blade 451b further applies to a back surface of the first ramming blade 451a.

The first ramming blade 451a may include a slot 452a and a mounting hole 454a positioned within the third portion 457a. The slot 452a may be positioned adjacent to or nearer a first end 453a (FIG. 4B) of the first ramming blade 451a, and the mounting hole 454a may be positioned adjacent to or nearer a second end 455a of the first ramming blade 451a. The slot 452a and the mounting hole 454a may be configured to be aligned with the plurality of holes 224 positioned adjacent the second end 223 of the tube 220. Alignment of the slot 452a and the mounting hole 454a with the plurality of holes 224 may permit insertion of a coupling fastener (e.g., a bolt, screw, rivet, or the like) to securely attach the first ramming blade 451a to the second end 223 of the tube 220. Similarly, the second ramming blade 451b may include a slot 452b and a mounting hole 454b positioned within the third portion 457b. The slot 452b and the mounting hole 454b may be configured to be aligned with the plurality of holes 224 positioned adjacent the second end 223 of the tube 220. Alignment of the slot 452b and the mounting hole 454b with the plurality of holes 224 may permit insertion of a coupling fastener (e.g., a bolt, screw, rivet, or the like) to securely attach the second ramming blade 451b to the second end 223 of the tube 220. In some examples, a coupling fastener may extend from the first ramming blade 451a through the tube 220 and through the second ramming blade 451b, thereby securely fastening each ramming blade 451a, 451b to the tube 220.

In use, the back surface of the third portion 457a of the first ramming blade 451a and the back surface 459b of the third portion 457b of the second ramming blade 451b may each be positioned adjacent the second end 223 of the tube 220 opposite from one another. The slots 452a, 452b and the mounting holes 454a, 454b may be aligned with the plurality of holes 224 positioned on opposite sides of the tube 220, adjacent the second end 223 of the tube 220. A first coupling fastener is then inserted through the slot 452a and the first hole 224a. In some examples, the first coupling fastener may further extend through the tube 220, through the fourth hole 224d, and through the slot 452b of the second ramming blade 451b. In other examples, another coupling fastener (independent of the first coupling fastener) may be inserted through the slot 452b and the fourth hole 224d. A second coupling fastener may then be inserted through the mounting hole 454a and the second hole 224b. In some examples, the second coupling fastener may further extend through the tube 220, through the fifth hole 224e, and through the mounting hole 454b of the second ramming blade 451b. In other examples, another coupling fastener (independent of the first coupling fastener) may be inserted through the mounting hole 454b and the fifth hole 224e. The coupling fasteners serve to securely attach the ramming blade attachment 450 to the second end 223 of the tube 220 to aid in driving (or ramming) the pile 500 into an underlying ground by increasing soil resistance capacity.

The slot 452a may be configured to provide the ramming blade attachment 450 with flexibility by permitting lateral rotation of the first end 453a of the first ramming blade 451a relative to the second end 455a about a pivot axis of the mounting hole 454a, and lateral rotation of the first end 453b of the second ramming blade 451b relative to the second end 455b about a pivot axis of the mounting hole 454b. In some examples, as the pile 400 is driven (or rammed) into an underlying ground surface, the pile 400 may encounter diverse soil conditions (e.g., rocks, sand, clay, etc.), which may necessitate flexibility of the ramming blade attachment 450. As such, the first ramming blade 451a may rotate laterally the distance of the slot 452a, and the second ramming blade 451b may rotate laterally the distance of the slot 452b. In some examples the first ramming blade 451a and the second ramming blade 451b may rotate in the same direction (e.g., east-west, north-south, etc.), while in other examples the first ramming blade 451a may rotate while the second ramming blade 451b remains stationary, and vice versa. In yet other examples, the first ramming blade 451a may rotate in one direction while the second ramming blade 451b may rotate in an opposite direction.

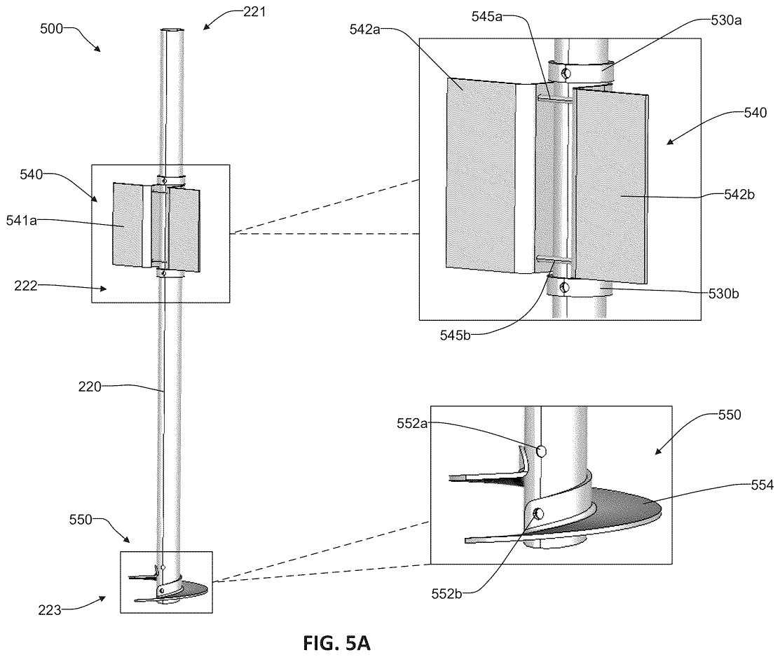

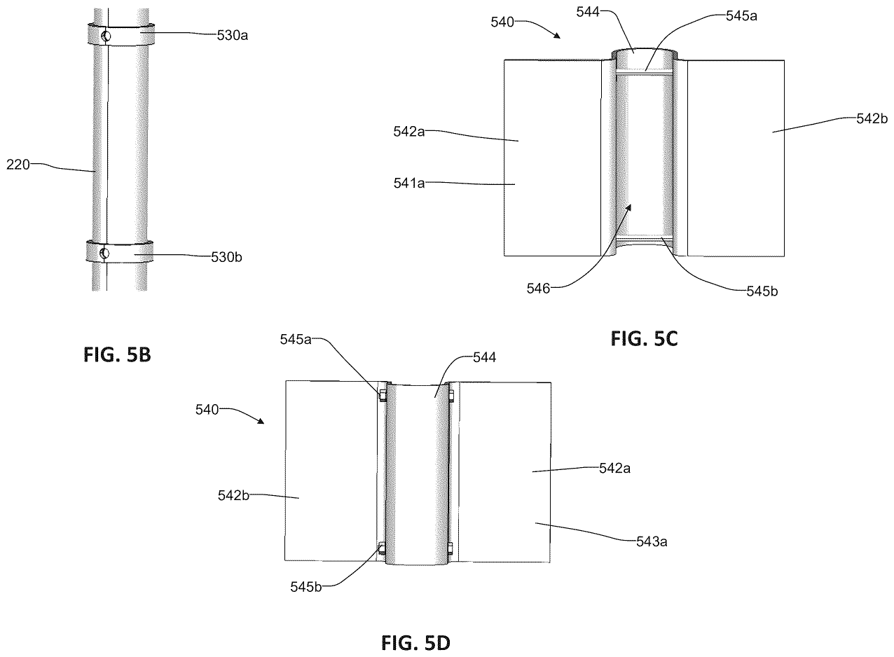

FIG. 5A is a perspective view of an example solar tracker foundation pile 500 in accordance with the disclosure. FIG. 5B is an isolated, perspective view of a portion of the solar tracker foundation pile 500, including a first ring bracket 530a and a second ring bracket 530b, FIG. 5C is an isolated, front-side view of a stabilizing panel 540 of the solar tracker foundation pile 500, and FIG. 5D is an isolated, back-side view of the stabilizing panel 540. The pile 500 may be a modular pile system 500 being formed from one of the two or more components, such as, for example, the tube 220 and the helical blade attachment 550.

As shown in FIG. 5A, the pile 500 may include the helical blade attachment 550. While it is shown that there is one helical blade 554 on the helical blade attachment 550, it may be contemplated that there may be two, three, four, six, or any number of blades as desired. The helical blade attachment 550 may be configured to be coupled to the tube 220 via one or more holes 552. While it is shown that there are two holes 552a, 552b (generally referred to herein as holes 552), it may be contemplated that there is one hole, three holes, five holes, or any other number of holes as desired. The holes 552 may be configured to be aligned with the plurality of holes 224 positioned adjacent the second end 223 of the tube 220. Alignment of the holes 552 with the plurality of holes 224 may permit insertion of a coupling fastener (e.g., a bolt, screw, rivet, or the like) to securely attach the screw attachment 350 to the second end 223 of the tube 220. The slanted edge 228 of the second end 223 of the tube 220 may be exposed beyond the helical blade attachment 550. The exposure of the slanted edge 228 permits engagement of the slanted edge 228 with an underlying ground to aid in driving the pile 500 into the ground.

The helical blade 554 may be positioned adjacent or closer to the second end 223 of the tube 220. The helical blade 554 of the helical blade attachment 550 may extend a single or multiple revolutions around the longitudinal axis L. The helical blade 554 of the helical blade attachment 550 may extend away from the longitudinal axis L of the hollow tube 220, and may also extend complete or partial revolutions around the longitudinal axis L. While it is shown that the helical blade 554 of the helical blade attachment 550 is located along the longitudinal axis L of the hollow tube 220 closer to the second end 223, it may be contemplated that the helical blade 554 may be located adjacent or closer to the first end 221, a central portion 222, or any other suitable portion along the longitudinal axis L of the hollow tube 220. The helical blade 554 may be configured for engaging with the ground in which the pile 500 is implanted by being screwed or threaded into the ground to anchor the solar tracker 10.

As shown in FIGS. 5A to 5D, the stabilizing panel 540 (generally referred to herein as panel 540) may be rotatably engaged with the tube 220. The panel 540 may include a first surface 541 (FIG. 5C) and a second surface 543 (FIG. 5D) opposite the first surface 541. The second, opposing surface 543 may be radially outward of the first surface 541 relative to the longitudinal axis L of the tube 220. The panel 540 may include a first portion 542a, a second portion 542b, and a third portion 544. The second portion 542b may extend in an opposing direction lateral to the first portion 542a and with the longitudinal axis L of the tube 220 between (either while offset therefrom or when directly between). The third portion 544 may include a shape configured to fit around the outer perimeter of the tube 220. The third portion 544 may, for instance, be U-shaped, C-shaped, or other shape that permits rotation of the third portion 544 around the outer perimeter of the tube 220. One end of the U-shape, C-shape, or otherwise of the third portion 544 may connect to the first portion 542a and the other end to second portion 542b. Thus, the third portion 544 may be configured to wrap around the tube 220 and couple the first portion 542a to the second portion 542b. A gap 546 may or may not be present. As shown in FIGS. 5C and 5D, the third portion 544 may include a U-shape. In some examples, the third portion 544 may include a hexagonal shape, a square shape, a rectangular shape, a triangular shape, a polygonal shape, or any other shape that still permits rotation about the tube 220.

The stabilizing panel 540 may connect to the tube 220 via one or more bolts 545a, 545b that may extend across the gap 546 from the first portion 542a to the second portion 542b. Thus, the third portion 544 and the one or more bolts 545a, 545b work together to couple the panel 540 to the tube 220 while permitting rotation of the panel 540 relative to the tube 220. The tube 220 may include a first ring bracket 530a and a second ring bracket 530b (FIG. 5B). First ring bracket 530a is located on one axial side of panel 540 and second ring bracket 530b is located on the opposite axial side of panel 540. First ring bracket 530a and second ring bracket 530b have a larger radius than the tube 220 and a radius that extends further away from the central axis L than third portion 544. By extending further outward from longitudinal axis L than the third portion 544, the first ring bracket 530a and the second ring bracket 530b function as axial stops for the panel 540 and maintain the panel 540 axially between the first ring bracket 530a and the second ring bracket 530b.

The first ring bracket 530a and the second ring bracket 530b may be formed in many ways and in many different shapes, including by attaching a band around tube 220 or by forming an enlarged sections integrally with tube 220. The first ring bracket 530a and the second ring bracket 530b need not be continuous around tube 220 and may be formed of one or more discrete sections formed on the tube 220.

The first ring bracket 530a and the second ring bracket 530b, and the one or more bolts 545a, 545b may cooperate to permit rotation of the panel 540 relative to the tube 220 while maintaining the orientation of the panel 540 relative to the central longitudinal axis L of the tube 220, such that the panel 540 may be continuously rotatable around the entirety of the tube 220.

In some examples, the stabilizing panel 540 may be positioned along the central longitudinal axis L at a longitudinal position closer to the first end 221 than a longitudinal position of the helical blade attachment 550. In other examples, the panel 540 may be positioned along the central longitudinal axis L at a longitudinal position closer to the central portion 222 of the tube 220. The position of the panel 540 may be such that the helical blade attachment 550 will not overlap longitudinally with the stabilizing panel 540. The longitudinal position of the stabilizing panel 540 may be rotatably engaged with the tube 220 such that the panel 540 may remain consistent (e.g., stationary) relative to the longitudinal axis L of the tube 220 when the tube 220 rotates relative to the stabilizing panel 540.

The stabilizing panel 540 may serve to provide support to the tube 220 to help prevent the tube 220 from tipping over in the ground in which the tube 220 is implanted. The panel 540 may further provide high lateral stability and resistance to dynamic loads and may be well-suited for solar tracker installations in regions prone to wind gusts and seismic activity.

The stabilizing panel 540 may be formed from aluminum, brass, carbon, stainless steel, copper, or other metal alloys. In some examples, the panel 540 may include a square cross-section. In other examples, the panel 540 may include a hexagonal cross-section, a rectangular cross-section, a triangular cross-section, a circular cross-section, a polygonal cross-section, or the like.

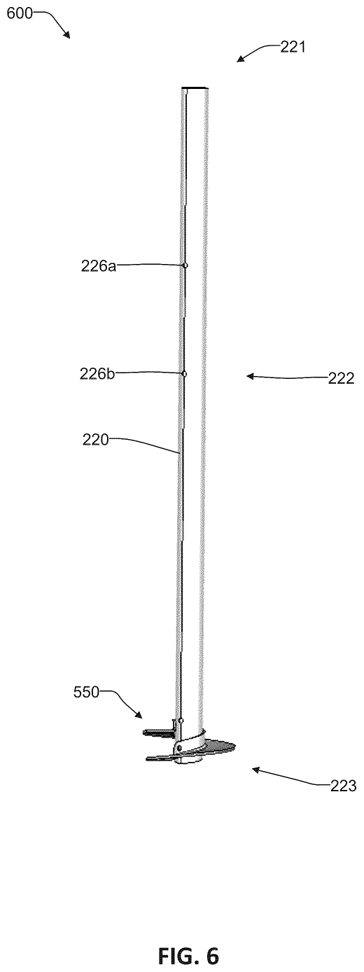

In some examples, the pile 500 may not include the stabilizing panel 540, as shown in FIG. 6. FIG. 6 is a perspective view of an example solar tracker foundation pile 600 in accordance with the disclosure. The pile 600 is like the pile 500, except that the pile 600 does not include the panel 540.

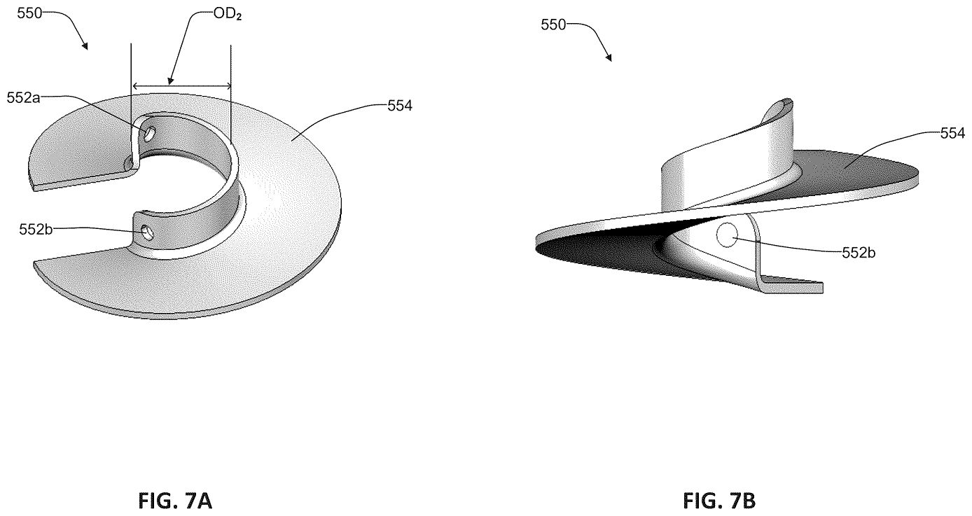

FIG. 7A is an isolated, perspective view of the helical blade attachment 550, and FIG. 7B is a rear-side view of the helical blade attachment 550. As previously discussed, while it is shown that there is one helical blade 554 on the helical blade attachment 550, it may be contemplated that there may be two, three, four, six, or any number of blades as desired. The helical blade attachment 550 may be configured to be coupled to the tube 220 via one or more holes 552. While it is shown that there are two holes 552a, 552b (generally referred to herein as holes 552), it may be contemplated that there may be one hole, three holes, five holes, or any other number of holes as desired.

The helical blade attachment 550 may extend a single or multiple revolutions around the longitudinal axis L and may include an outer diameter OD₂ (FIG. 7A) that is greater than the outer diameter OD₁ of the tube 220. Thus, the helical blade attachment 550 may be configured to fit over and around the second end 223 of the tube 220. The helical blade 550 may extend away from the longitudinal axis L of the hollow tube 220, and may also extend complete or partial revolutions around the longitudinal axis L. In some cases, a cross-section of the helical blade 554 may be non-circular in shape as the helical blade 554 extends in an outward direction from the longitudinal axis L of the tube 220. Although this may not always be the case. In some cases, the cross-section of the helical blade 554 may include a circular cross-section. In other cases, the cross-section of the helical blade 554 may include an oval cross-section, a polygonal cross-section, or any other suitable cross-section as desired. Further, while it is shown that the helical blade attachment 550 includes the helical blade 554, it may be contemplated that other types of blades may be used. Such as for example, angled blades, helical ridges, vertical ridges, spade blades, and paddle blades. These are just examples.

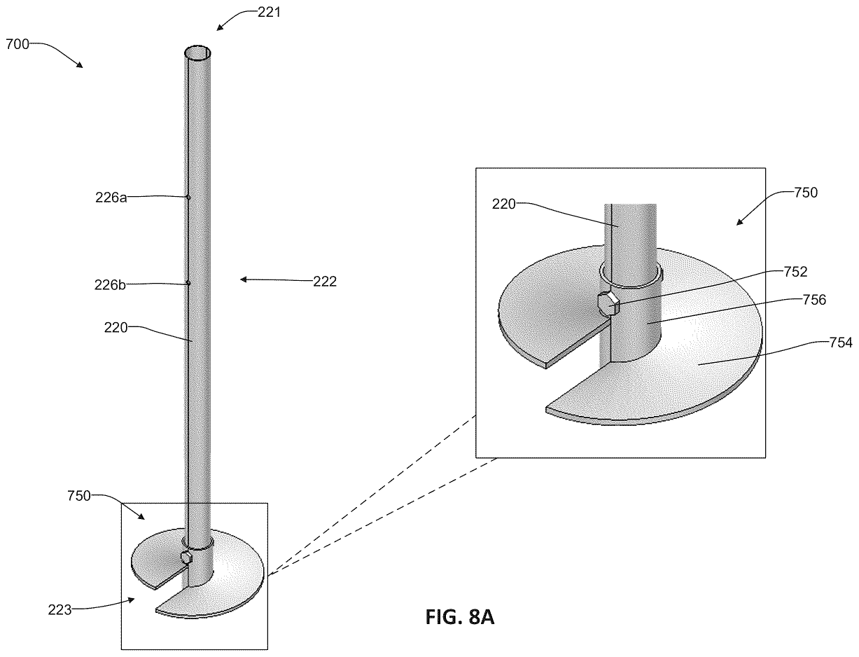

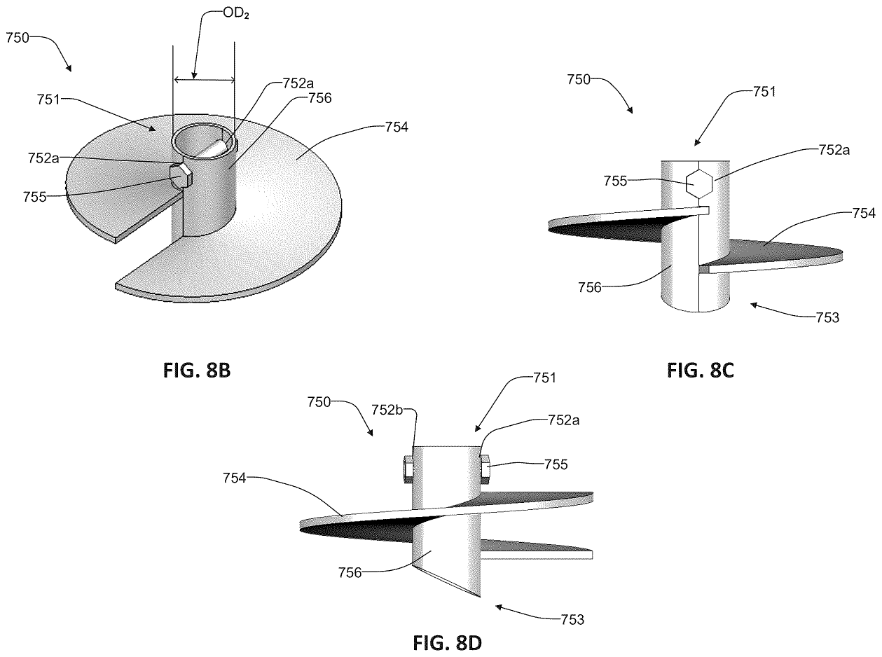

FIG. 8A is a perspective view of an example solar tracker foundation pile 700 in accordance with the disclosure. FIG. 8B is an isolated, perspective view of a helical blade attachment 750, FIG. 8C is an isolated, right-side view of the helical blade attachment 750, and FIG. 8D is an isolated, back-side view of the helical blade attachment 750. The pile 700 may be a modular pile system 700 being formed from one of the two or more components, such as, for example, the tube 220 and the helical blade attachment 750.

As shown in FIG. 8A, the pile 700 may include the helical blade attachment 750. While it is shown that there is one helical blade 754 on the helical blade attachment 750, it may be contemplated that there may be two, three, four, six, or any number of blades as desired. The helical blade attachment 750 may be configured to be coupled to the tube 220 via a sleeve 756 which may include one or more holes 752. The first end 751 and/or the second end 753 of the sleeve 756 of the helical blade attachment 750 may be an open end and may include an outer diameter OD₂ (FIG. 8B) that is greater than the outer diameter OD₁ of the tube 220. Thus, the helical blade attachment 750 may be configured to fit over and around the second end 223 of the tube 220. In some examples, the outer diameter OD₂ of the sleeve 756 may be slightly larger than the outer diameter OD₁ of the tube 220 to ensure a tighter fit and minimize any gap that may be formed between the tube 220 and the helical blade attachment 750. In some examples, the first end 751 of the helical blade attachment 750 may be positioned adjacent the second end 223 of the tube 220 and may slide axially over the second end 223 of the tube 220. The sleeve 756 of the helical blade attachment 750 may move axially over the second end 223 of the tube 220 until one or more holes 752a, 752b align with the plurality of holes 224 positioned adjacent the second end 223 of the tube 220. Alignment of the one or more holes 752a, 752b with the plurality of holes 224 may permit insertion of a coupling fastener 755 to securely attach the helical blade attachment 750 to the second end 223 of the tube 220. In some examples, the helical blade attachment 750 may be positioned over the second end 223 of the tube 220 such that the slanted edge 228 of the second end 223 of the tube 220 is exposed beyond the second end 753 of the helical blade attachment 750. The exposure of the slanted edge 228 permits engagement of the slanted edge 228 with an underlying ground to aid in driving the pile 700 into the ground.

The helical blade 754 may be positioned adjacent or closer to the second end 223 of the tube 220. The helical blade attachment 750 may extend a single or multiple revolutions around the longitudinal axis L. The helical blade 754 may extend away from the longitudinal axis L of the hollow tube 220, and may also extend complete or partial revolutions around the longitudinal axis L. While it is shown that the helical blade 754 of the helical blade attachment 750 is located along the longitudinal axis L of the hollow tube 220 closer to the second end 223, it may be contemplated that the helical blade 754 may be located adjacent or closer to the first end 221, a central portion 222, or any other suitable portion along the longitudinal axis L of the hollow tube 220. The helical blade 754 may be configured for engaging with the ground in which the pile 700 is implanted by being screwed or threaded into the ground to anchor the solar tracker 10.

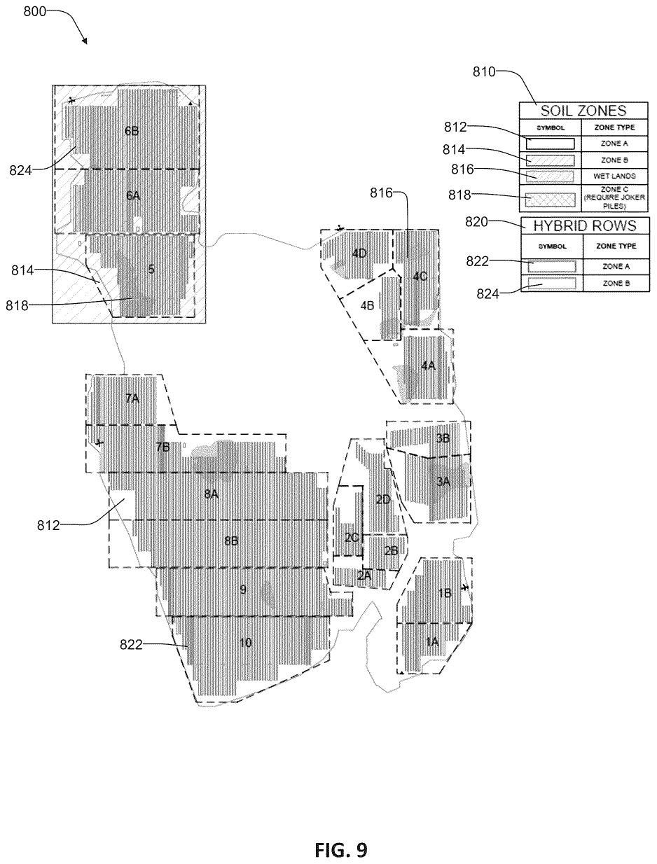

FIG. 9 illustrates an example grid map 800 in accordance with the present disclosure. The grid map 800 is an example of a solar tracker layout plan with geotechnical zoning for an area of land having various terrain in which solar trackers (e.g., solar tracker 10) are to be installed. Geotechnical zoning is done by evaluating the properties of the soil and/or rocks beneath the surface of the ground. In some examples, soil zones 810 are then assigned based upon the geotechnical evaluation of the underground surface. The soil zones 810 may include, for example, Zone A 812, Zone B 814, Wetlands 816, and Zone C 818. In some examples, the underground surface may include hybrid soil properties, as indicated by hybrid rows 820 on the grid map 800. The hybrid rows 820 may include, for example, Zona A 822, and Zone B 824.

The soil zones 810 and hybrid rows 820 may each differ from one another, and as such, may require different types of solar tracker piles. For example, Zone A 812 may be determined to include a higher sand content. In such cases, a helical pile (e.g., piles 500, 700) may provide a higher stability, thereby making it the preferred solar tracker pile for Zone A 812. Zone B 814 may be determined to include a dense clay content. In such cases, a screw pile (e.g., pile 300) or a ramming pile (e.g., pile 400) may provide high stability and higher-load bearing capabilities, making it the preferred solar tracker pile for Zone B 814. These are just examples.

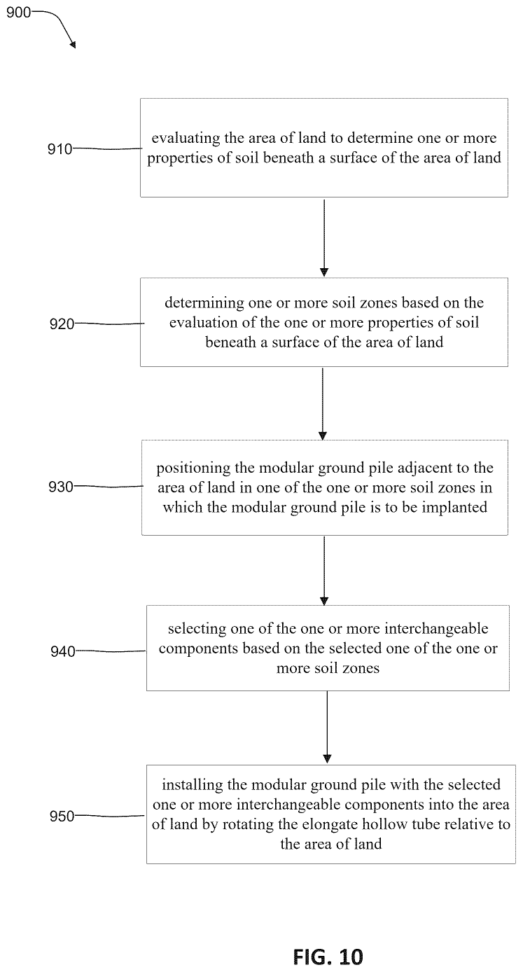

FIG. 10 is flow chart illustrating a method 900 of installing a modular pile system (e.g., ground piles 300, 400, 500, 600, 700) into an area of land having various terrain. The method 900 may include evaluating the area of land to determine one or more properties of soil beneath a surface of the area of land, as referenced by block 910. Evaluating the area of land to determine the properties of the soil and/or rocks beneath the surface of the ground may be accomplished via geotechnical zoning. One or more soil zones may be determined, based on the evaluation of the one or more properties of soil beneath a surface of the area of land, as referenced by block 920. The modular pile system may be positioned adjacent to the area of land in one of the one or more soil zones in which the modular ground pile is to be implanted, as referenced by block 930, and one of the one or more interchangeable components may be selected based on the selected one of the one or more soil zones, as referenced by block 940. The modular ground pile may be any one of the modular pile systems described herein. When the preferred modular ground pile has been selected and assembled, the modular ground pile having the selected one or more interchangeable components may be installed into the area of land by rotating the elongate hollow tube relative to the area of land, as referenced by block 950.

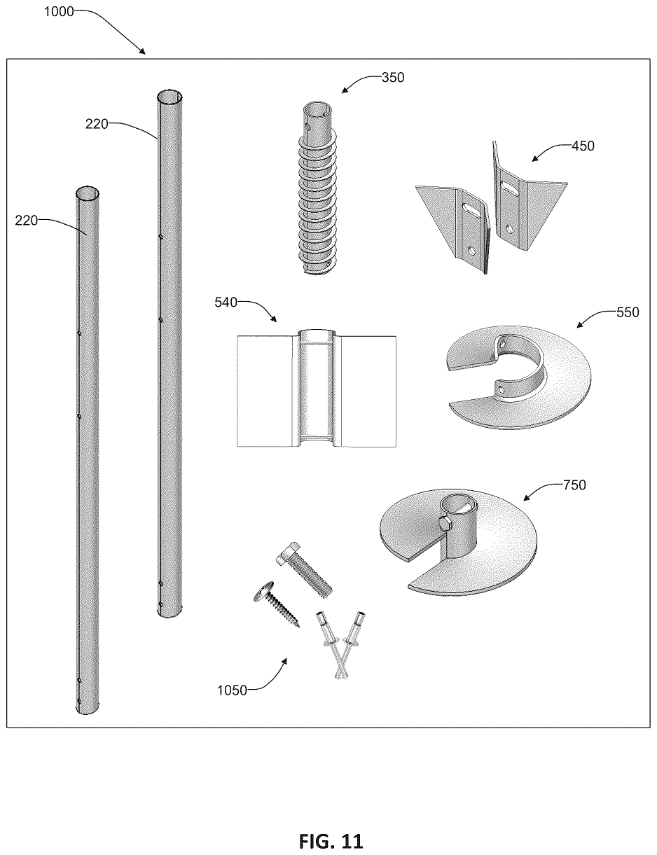

As shown in FIG. 11, in some examples, each of the ground piles 300, 400, 500, 600, 700 forming the modular pile system may be configured as a kit 1000 to be delivered to the area of land having various terrain. The kit 1000 for creating such modular pile systems for various types of soil may include a supply of the elongate hollow tubes 220, a supply of two or more types of interchangeable components, such as, for example, the screw attachment 350, the ramming blade attachment 450, the helical blade attachments 550, 750, and the stabilizing panel 540, wherein each component of the two or more types of interchangeable components (the screw attachment 350, the a ramming blade attachment 450, the helical blade attachments 550, 750, and the stabilizing panel 540) may be configured to be coupled to each elongate hollow tube 220 via mounting holes 226 and/or the plurality of holes 224. The kit may further include a supply of fasteners 1050, e.g., a bolt, screw, rivet, or the like, for connecting one of the components of the two or more types of interchangeable components (the screw attachment 350, the a ramming blade attachment 450, the helical blade attachments 550, 750, and the stabilizing panel 540) with one of the tubes 220 of the supply of elongate hollow tubes 220 via the one or more mounting holes 226 and/or the plurality of holes 224 of the tube 220.

Various non-limiting exemplary embodiments have been described. It will be appreciated that suitable alternatives are possible without departing from the scope of the examples described herein.

1. A modular pile system for a solar tracking system, comprising:
an elongate hollow tube extending longitudinally from a first end to a second end, the elongate tube having a longitudinal axis;
one or more mounting holes positioned along the longitudinal axis of the elongate hollow tube;
a plurality of holes positioned adjacent the second end of the elongate hollow tube; and
two or more interchangeable components configured to be coupled to the second end of the elongate hollow tube via the plurality of holes, the two or more interchangeable components configured for engaging with underlying ground in which the modular pile is implanted.

2. The modular pile system of claim 1, wherein the two or more interchangeable components each include a first end and a second end, the first end being an open end having an outer diameter that is greater than an outer diameter of the second end of the elongate tube.

3. The modular pile system of claim 2, wherein the two or more interchangeable components includes a helical pile attachment.

4. The modular pile system of claim 2, wherein the two or more interchangeable components includes a screw pile attachment.

5. The modular pile system of claim 1, wherein the two or more interchangeable components includes a ramming blade attachment.

6. The modular pile system of claim 5, wherein the ramming blade attachment includes a first ramming blade and a second ramming blade.

7. The modular pile system of claim 3, further comprising a stabilizing panel coupled to the elongate hollow tube, the stabilizing panel providing support to the tube to help prevent the tube from tipping over in soil in which the tube is implanted.

8. The modular pile system of claim 7, wherein the stabilizing panel is formed by first, second, and third portions, the third portion extending at least partially around the tube, the first and second portions extending in opposing directions away the third portion.

9. The modular pile system of claim 3, wherein the helical blade attachment includes a helical blade coupled to a sleeve, the sleeve configured to fit over and around the second end of the elongate hollow tube.

10. The modular pile system of claim 3, wherein the helical blade attachment includes a helical blade configured to fit over and around the second end of the elongate hollow tube.

11. The modular pile system of claim 1, wherein the second end of elongate hollow tube includes a slanted edge, the slanted edge including an angle in a range of about 10-degrees to about 30-degrees.

12. A method of installing a modular pile system into an area of land having various terrain, the method comprising:
evaluating the area of land to determine one or more properties of soil beneath a surface of the area of land;
determining one or more soil zones based on the evaluation of the one or more properties of soil beneath a surface of the area of land;
positioning the modular pile system adjacent to the area of land in one of the one or more soil zones in which the modular pile system is to be implanted, the modular pile system comprising:
an elongate hollow tube extending longitudinally from a first end to a second end, the elongate tube having a longitudinal axis;
one or more mounting holes positioned along the longitudinal axis of the elongate hollow tube;
a plurality of holes positioned adjacent the second end of the elongate hollow tube; and
two or more interchangeable components configured to be coupled to the second end of the elongate hollow tube via the plurality of holes, the two or more interchangeable components configured for engaging with soil in which the ground pile is implanted;
selecting one of the two or more interchangeable components based on the selected one of the one or more soil zones; and
installing the modular pile system with the selected one of the two or more interchangeable components into the area of land by rotating the elongate hollow tube relative to the area of land.

13. The method of claim 12, wherein the two or more interchangeable components includes a helical pile attachment.

14. The method of claim 12, wherein the two or more interchangeable components includes a screw pile attachment.

15. The method of claim 12, wherein the two or more interchangeable components includes a ramming blade attachment.

16. A kit for creating ground piles for various types of soil, comprising:
a supply of elongate hollow tubes each extending longitudinally from a first end to a second end, the elongate tube having a longitudinal axis;
one or more mounting holes in each of the supply of elongate hollow tubes positioned along the longitudinal axis of the elongate hollow tube;
a plurality of holes in each of the supply of elongate tubes positioned adjacent the second end of the elongate hollow tube;
a supply of two or more types of interchangeable components, each component of the two or more types of interchangeable components configured to be coupled to the second end of each elongate hollow tube via the plurality of holes, each component in the supply of two or more types of interchangeable components configured for engaging with soil in which the ground pile is implanted; and
a supply of fasteners, each fastener for connecting one of the components of the two or more types of interchangeable components with one of the tubes of the supply of elongate hollow tubes via the plurality of holes of the tube.

17. The kit of claim 16, wherein the two or more interchangeable components includes a helical pile attachment.

18. The kit of claim 16, wherein the two or more interchangeable components includes a screw pile attachment.

19. The kit of claim 16, wherein the two or more interchangeable components includes a ramming blade attachment.

20. The kit of claim 16, wherein the two or more interchangeable components further includes a stabilizing panel configured to be coupled to the one or more mounting holes in each positioned along the longitudinal axis of the elongate hollow tube.
